(19) United States
(12) Patent Application Publication
(10) Pub. No.: US 2008/0124461 A1
(43) Pub. Date: May 29, 2008

(54) LAMINATOR AND METHOD OF LAMINATION

(76) Inventors: Antoine De Leener, Westerlo (BE); Bart Verleije, Kalmthout (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/868,025

(22) Filed: Oct. 5, 2007

Related U.S. Application Data
(60) Provisional application No. 60/863,266, filed on Oct. 27, 2006.

(30) Foreign Application Priority Data
Oct. 24, 2006 (EP) 06122782.3

(51) Int. Cl. B05D 1/28; B29C 51/00

(52) U.S. Cl. 427/211; 118/202

(57) ABSTRACT

A laminator for multiplex entities comprising at least one pair of driven cylinders, the outermost surface of the cylinders being coated with a thermally conductive elastic material such that in operation the cylinders fail to make physical contact with one another for a period during each rotation, wherein each of the cylinders is provided with at least one heating means, the elastic material coating has a constant thickness for at least 50% of the circumference of the cylinders and the part of the circumference of the cylinders with an elastic material having a constant thickness is at least the length of the multiplex entities in the transport direction thereof; and a lamination process for producing a multiplex entity comprising the steps of: providing at least one pair of driven cylinders, the outermost surface of the cylinders being coated with a thermally conductive elastic material such that in operation the cylinders fail to make physical contact with one another for a period during each rotation, wherein each of the cylinders is provided with at least one heating means, the elastic material coating has a constant thickness for at least 50% of the circumference of the cylinders and the part of the circumference of the cylinders with an elastic material having a constant thickness is at least the length of the multiplex entity in the transport direction thereof; and transporting a multiplicity of elements to be laminated so that the initial part of the multiplicity of elements to be laminated is not touched by the coated cylinders and the rest of the multiplicity of elements to be laminated is laminated in the nip formed by the areas of the elastic coating having a constant thickness of the cylinders.

### CROSS-REFERENCE TO RELATED PATENT APPLICATIONS

This application claims the benefit of U.S. Provisional Application No. 60/863,266 filed Oct. 27, 2006, which is incorporated by reference. In addition, this application claims the benefit of European Application No. 06122782.3 filed Oct. 24, 2006, which is also incorporated by reference.

### FIELD OF THE INVENTION

The invention relates to lamination equipment used to laminate multiplex entities at high speeds in a discontinuous process, e.g. in the production of data bearing identification and financial documents including plastic cards such as financial (e.g. credit and debit) cards, driving licenses, national identification cards, and other similar cards, as well as other identification and financial documents, such as passports.

### BACKGROUND OF THE INVENTION

The use of laminated identification and financial documents, such as financial (e.g. credit and debit) cards, driving licenses, national identification cards, and other like cards, as well as passports and the like, is well known. The documents are typically provided with one or more of printed characters and/or images, holographic images, embossed characters, laser-produced information, and data storage media such as an integrated circuit chip.

EP 1 176 382A discloses a roller arrangement suitable for use in a laminating machine, the roller arrangement comprising: a laminating roller of substantially cylindrical shape; a curved plate disposed around at least a part of the outer cylindrical surface of the laminating roller, the curved plate having a shape generally in conformance with that of the outer cylindrical surface of the laminating roller; a heating layer in the form of a paste integral with at least a part of the outer surface of the plate; whereby when the heating layer is activated the laminating roller is heated by the curved plate. However, although EP 1 176 382A disclosed that the curved plate is disposed around at least part of the outer cylindrical surface of the laminating roller, it is not contiguous with it as is clear from the disclosure in EP 1 176 382A that “since stainless steel is a good radiator of heat, this heat is radiated from the stainless steel halves 2′ to the laminating rollers 8, 10, and thus the surfaces of laminating rollers 8, 10 also heat up” and FIGS. 2 and 3. Moreover, EP 1 176 382A discloses that the cylinder of FIG. 1 is separated into two haves to provide two curved heating plates and that laminating rollers 8 and 10 are solid cylindrical rollers.

It is generally preferable that the lamina have a size that approximates the surface of the document so that the entire document surface is protected. A known method for applying a topcoat to a document is to laminate to the document surface a lamina that has a size greater than the size of the document surface. The edges of the lamina that extend beyond the edges of the document are then trimmed or cut to the size of the document. Adhesion of the lamina is obtained by the use of adhesives, which become liquid upon coming into contact with a heated roller pair or by the use of lamina of low melting point polymers which melt during the lamination process. At the pressure between the rollers applied during the lamination process such hot melt adhesives and low melting polymers will be extruded round the edges of the multiplex entities being laminated and this extruded hot melt adhesive/low melting point polymer will be deposited onto the laminator rollers, where it will accumulate leading eventually to a contamination level at which the laminate produced itself becomes contaminated. This conventionally is dealt with by regularly cleaning the rollers, replacing the rollers or providing a means of continuously removing the deposited hot melt adhesive/low melting point polymer from the rollers during use. However, with a discontinuous process the possibility of providing a means of continuously removing the deposited hot melt adhesive/low melting point polymer from the rollers during use is mechanically complicated and hence expensive and unreliable.

A need therefor exists for a means of preventing the build-up of hot melt adhesive/low melting point polymers on laminator rollers in a discontinuous lamination process.

### ASPECTS OF THE INVENTION

It is an aspect of the present invention to provide a means of preventing the build-up of hot melt adhesive/low melting point polymers on laminator rollers in a discontinuous lamination process.

It is a further aspect of the present invention to provide a laminator which is not under pressure, when not in use.

It is also an aspect of the present invention to provide a laminator capable of preventing the build-up of hot melt adhesive/low melting point polymers on laminator rollers in a discontinuous lamination process.

Further aspects of the invention will become apparent from the description hereinafter.

### SUMMARY OF THE INVENTION

Prior art laminators suitable for use in high speed processes in a discontinuous lamination process become rapidly contaminated by the adhesives used in the lamination process. This contamination has an adverse effect on the lamination process as a result of the offset of the contamination in and on the resulting laminate. It has been surprisingly found that provided the circumference of the rounded sector of the roller is at least the length of the multiplex card being laminated; the contamination of the rollers in the laminating unit and the offset of this contamination in and/or on the resulting laminate can be substantially reduced by using rubber-coated rollers with at least one roller in a pair of rollers having at least one flat area over the whole length of the cylinder parallel to the axis of the cylinder.

Aspects of the present invention have been realized by a laminator for multiplex entities comprising at least one pair of driven cylinders, the outermost surface of the cylinders being coated with a thermally conductive elastic material such that in operation the cylinders fail to make physical contact with one another for a period during each rotation, wherein each of the cylinders is provided with at least one heating means, the elastic material coating has a constant thickness for at least 50% of the circumference of the cylinders and the part of the circumference of the cylinders with an elastic material having a constant thickness is at least the length of the multiplex entities in the transport direction thereof.

Aspects of the present invention have also been realized by a lamination process for producing a multiplex entity comprising the steps of: providing at least one pair of driven cylinders, the outermost surface of the cylinders being coated with a thermally conductive elastic material such that in operation the cylinders fail to make physical contact with one another for a period during each rotation, wherein each of the cylinders is provided with at least one heating means, the elastic material coating has a constant thickness for at least 50% of the circumference of the cylinders and the part of the circumference of the cylinders with an elastic material having a constant thickness is at least the length of the multiplex entity in the transport direction thereof; and transporting a multiplicity of elements to be laminated so that the initial part of the multiplicity of elements to be laminated is not touched by the coated cylinders and the rest of the multiplicity of elements to be laminated is laminated in the nip formed by the areas of the elastic coating having a constant thickness of the cylinders.

Further advantages and embodiments of the present invention will become apparent from the following description.

### BRIEF DESCRIPTION OF THE DRAWINGS

FIG. 1 is a schematic drawing of a cylinder, 1, coated with a thermally conductive elastic coating, 2, with a flat side, 3, according to the present invention.

FIGS. 2a, 2b and 2c are schematic drawings of three stages in the lamination process, according to the present invention: FIG. 2a shows the beginning of the lamination process in which an end of the multiplicity of elements, 4, to be laminated, 4, is between but not yet in contact with the heated, coated cylinders, 5 and 5′; FIG. 2b shows the multiplicity of elements, 4, being laminated by the pair of heated, coated driven cylinders, 5 and 5′; and FIG. 2c shows the situation after lamination as the laminated multiplicity of elements, 4, leaves the pair of heated, coated driven cylinders, 5 and 5′.

FIGS. 3a, 3b and 3c are side-on schematic drawings of the three stages in the lamination process, according to the present invention shown in FIGS. 2a, 2b and 2c.

### DETAILED DESCRIPTION OF THE INVENTION

### Definitions

The term “identification document” or “ID document”, as used in disclosing the present invention means a document bearing identifying data about the product or the individual whose name appears thereon. ID documents include credit cards, bank cards, phone cards, passports, driving licenses, network access cards, employee badges, debit cards, security cards, visas, immigration documentation, national ID cards, citizenship cards, social security cards, security badges, certificates, identification cards or documents, voter registration cards, police ID cards, border crossing cards, legal instruments, security clearance badges and cards, gun permits, gift certificates or cards, membership cards and badges. The terms “document,” “card,” “badge” and “documentation” are used interchangeably throughout this patent application.

The term “to laminate”, as used in disclosing the present invention, means to bond together two or more sheet materials.

### Laminator

Aspects of the present invention have been realized by a laminator for multiplex entities comprising at least one pair of driven cylinders, the outermost surface of the cylinders being coated with a thermally conductive elastic material such that in operation the cylinders fail to make physical contact with one another for a period during each rotation, wherein each of the cylinders is provided with at least one heating means, the elastic material coating has a constant thickness for at least 50% of the circumference of the cylinders and the part of the circumference of the cylinders with an elastic material having a constant thickness is at least the length of the multiplex entities in the transport direction thereof.

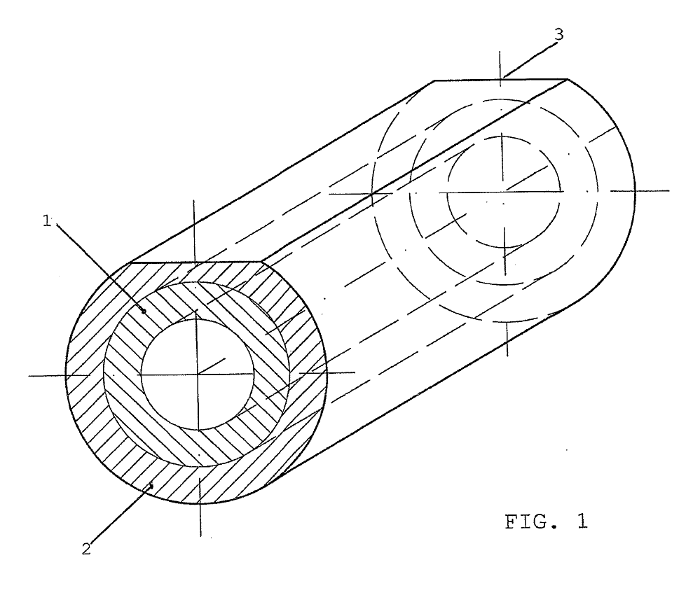

FIG. 1 is a schematic drawing of a cylinder, 1, coated with a thermally conductive elastic coating, 2, with a flat side, 3, according to one embodiment of the present invention.

According to a first embodiment of the laminator, according to the present invention, the failure to make physical contact with one another in operation is due to a non-coated area strip on at least one of the coated driven cylinders.

According to a second embodiment of the laminator, according to the present invention, the failure to make physical contact with one another in operation is due to a non-coated area strip on both of the coated driven cylinders.

According to a third embodiment of the laminator, according to the present invention, the failure to make physical contact with one another in operation is due to a concave strip of the thermally conductive elastic material on at least one of the driven cylinders.

According to a fourth embodiment of the laminator, according to the present invention, the failure to make physical contact with one another in operation is due to a concave strip of the thermally conductive elastic material on both of the driven cylinders.

According to a fifth embodiment of the laminator, according to the present invention, the failure to make physical contact with one another in operation is due to the elastic coating on at least one of the cylinders having at least one flat area over the whole length of the cylinder parallel to the axis of the cylinder which has a symmetrical profile perpendicular to the axis.

According to a sixth embodiment of the laminator, according to the present invention, the failure to make physical contact with one another in operation is due to the elastic coating on both of the cylinders having at least one flat area over the whole length of the cylinder parallel to the axis of the cylinder which has a symmetrical profile perpendicular to the axis.

According to a seventh embodiment of the laminator, according to the present invention, the laminator additionally comprises two further pairs of driven cylinders, each having the same configuration as the pair of driven cylinders and the two further pairs of driven cylinders are each provided with at least one heating means.

According to an eighth embodiment of the laminator, according to the present invention, the multiplex entity is an identification document precursor.

According to a ninth embodiment of the laminator, according to the present invention, the constant thickness is at least 5 mm, preferably at least 7 mm with at least 10 mm being particularly preferred.

According to a tenth embodiment of the laminator, according to the present invention, the thermally conductive elastic coating of the cylinders in the pair of cylinders each have at least one flat area over the whole length of the cylinder parallel to the axis of the cylinder which has a symmetrical profile perpendicular to the axis and a flat side of one of the coated cylinders is opposite to a flat side of the other coated cylinder when the coated cylinders are at rest.

According to an eleventh embodiment of the laminator, according to the present invention, the flat side is used as a synchronization point in the set-up of an identity document manufacturing cycle.

According to a twelfth embodiment of the laminator, according to the present invention, the to be laminated material is transported through the laminator mounted on a chain system. For example in the AnaIS®-system the system is driven by a chain on the basis of multiples of 127 mm i.e. 100 mm/coupon with a 27 mm gap between coupons. In the manufacturing of polyester multiplex entities the laminator preferably operates at a temperature of 170 to 180° C.

According to a thirteenth embodiment of the laminator, according to the present invention, the thermally conductive elastic coating of the cylinders in the pair of cylinders each have at least one flat area over the whole length of the cylinder parallel to the axis of the cylinder which has a symmetrical profile perpendicular to the axis and a flat side of one of the coated cylinders is opposite to a flat side of the other coated cylinder when the coated cylinders are at rest.

According to a fourteenth embodiment of the laminator, according to the present invention, the pressure between the two coated cylinders is exclusively due to the expansion of the thermally conductive elastic material coating on the cylinders.

According to a fifteenth embodiment of the laminator, according to the present invention, the laminator is capable of symmetric lamination of a substantially identical lamella each side of a support, where substantially means that only the polymeric nature of the lamella is taken into account.

### Cylinders Coated on their Outermost Surfaces with a Thermally Conductive Elastic Material

The laminator comprises at least one pair of cylinders coated on their outermost surfaces with a thermally conductive elastic material, so-called rollers.

According to a sixteenth embodiment of the laminator, according to the present invention, the cylinders are made of aluminium.

The thermally conductive elastic material has sufficient resilience and thickness to provide a nip between the cylinders of the cylinder pair e.g. has a Shore A hardness of less than 90 e.g. a Shore A hardness of 60. The thermally conductive elastic material may be in-situ vulcanized.

Thermal conductivity can be provided by fillers such as fine metal particles, carbon black, graphite and haematite.

According to a seventeenth embodiment of the laminator, according to the present invention, the thermally elastic material is a carbon-filled silicone rubber. Silicone rubber adheres well to aluminium.

According to an eighteenth embodiment of the laminator, according to the present invention, the thermally elastic material has a Shore A hardness of less than 90.

A standard identity card has a length of ca. 85.6 mm, which may be cut from a blank having a length of ca. 100 mm. A preferred coated cylinder has two flat sides each ca. 27 mm wide and has two parts of the circumference with an elastic material having a constant thickness each ca. 100 mm long.

During lamination of a multilayer polyester-based support on both sides with a PET-foil coated with polyethylene with the temperature of the aluminium cylinder regulated to a temperature of ca. 200° C. (190° to 210° C.) and filled silicone rubber as the thermally conductive elastic material heated to a temperature of ca. 180° C. (165 to 190°). Contamination of the coated cylinders with molten polyethylene cannot arise from the leading edge of the multiplex entity, since there is no contact with the coated cylinders at this stage in the process, but does arise in the area of the curved surface behind the multiplex entity. Therefore no polyethylene is deposited on the resulting multiplex entity and contamination of the multiplex entity is avoided.

According to a nineteenth embodiment of the laminator, according to the present invention, the circumference of each coated cylinder is 240 mm.

Flat spots in the thermal conductive elastic material coating on the at least 50% of the circumference of the cylinder having a constant thickness can be avoided by “parking” the pair of driven cylinders with a flat area at the nearest point to the other cylinder of the cylinder pair, but not in contact with it, or with flat areas of each cylinder of the cylinder pair opposite one another, but not in contact.

According to a twentieth embodiment of the laminator, according to the present invention, the heating means is exclusive of resistive heating of the thermally conductive elastic material.

### Heating Means

The heating means can be an internal heating source such as an incandescent filament bulb and/or external such as an incandescent filament bulb with a reflector to concentrate the radiation onto the thermally conductive elastic material.

The cylinders can be further provided with a temperature regulation device such as a thermistor or a pyrometer.

### Lamination Process for Producing a Multiplex Card

Aspects of the present invention have also been realized by a lamination process for producing a multiplex entity comprising the steps of: providing at least one pair of driven cylinders, the outermost surface of the cylinders being coated with a thermally conductive elastic material such that in operation the cylinders fail to make physical contact with one another for a period during each rotation, wherein each of the cylinders is provided with at least one heating means, the elastic material coating has a constant thickness for at least 50% of the circumference of the cylinders and the part of the circumference of the cylinders with an elastic material having a constant thickness is at least the length of the multiplex entity in the transport direction thereof; and transporting a multiplicity of elements to be laminated so that the initial part of the multiplicity of elements to be laminated is not touched by the coated cylinders and the rest of the multiplicity of elements to be laminated is laminated in the nip formed by the areas of the elastic coating having a constant thickness of the cylinders.

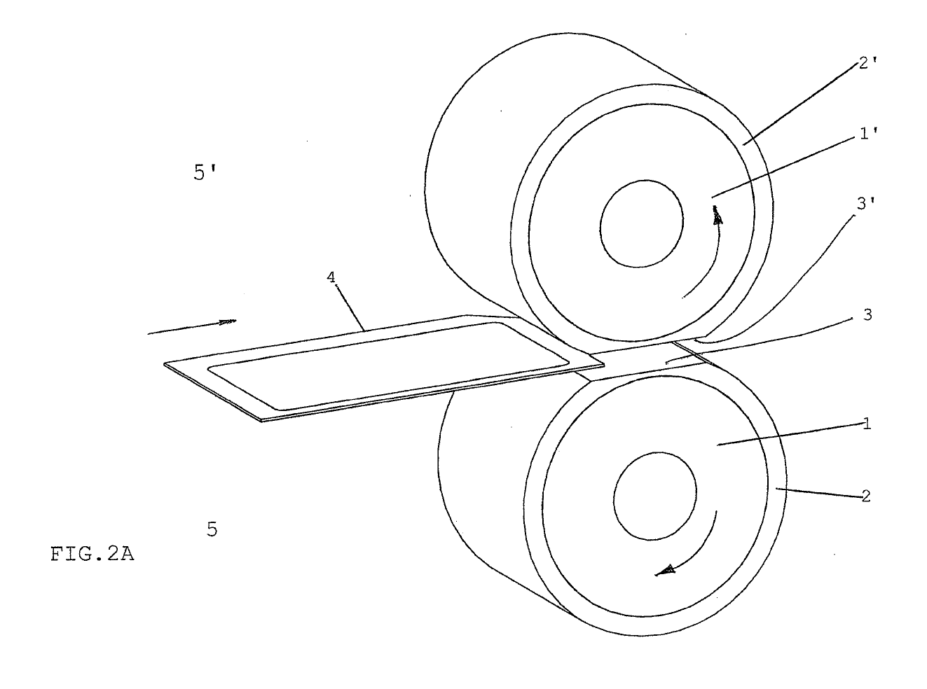

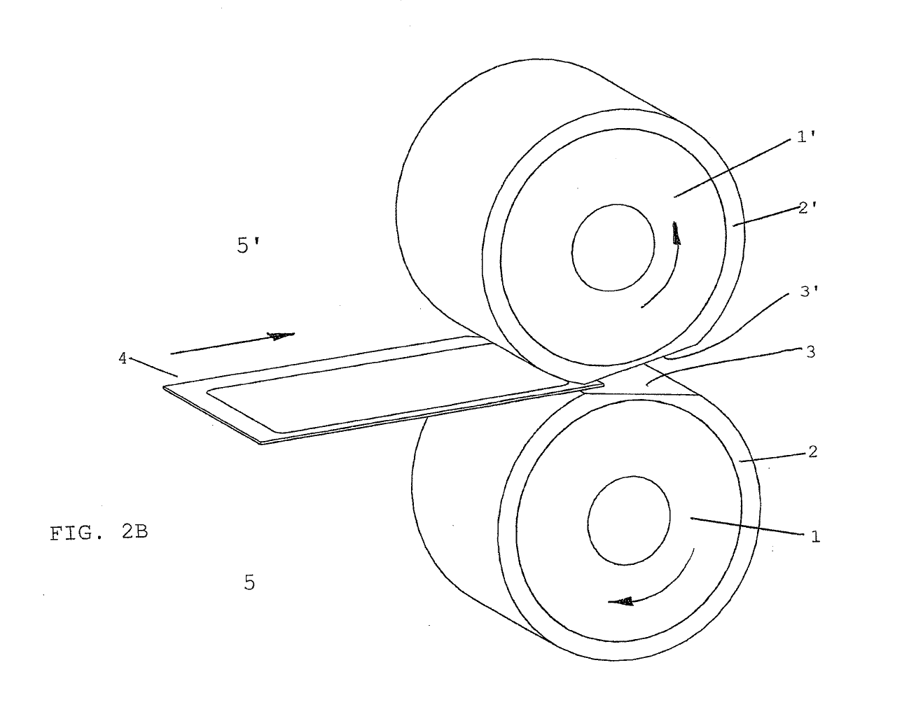

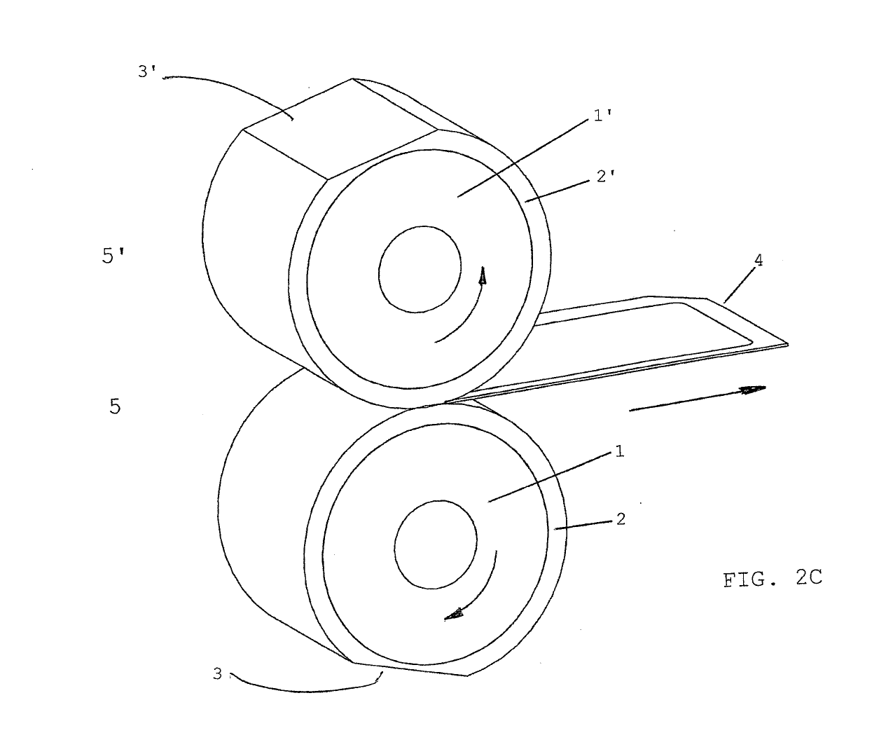

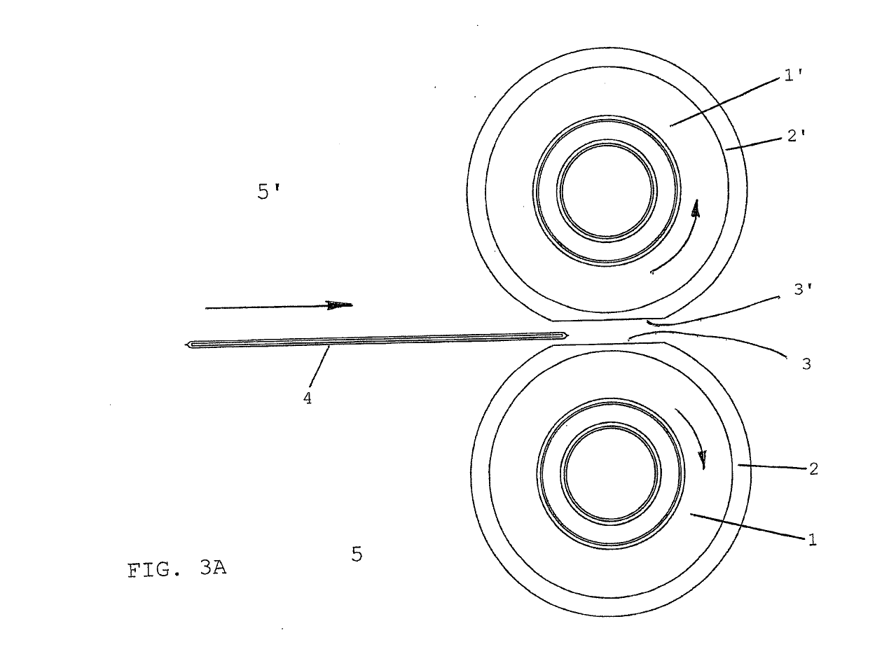

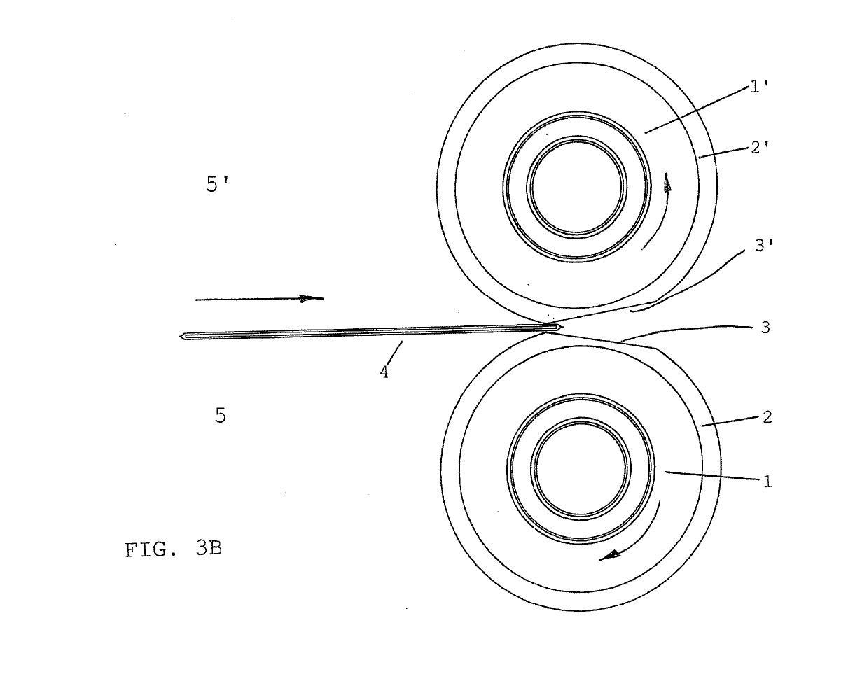

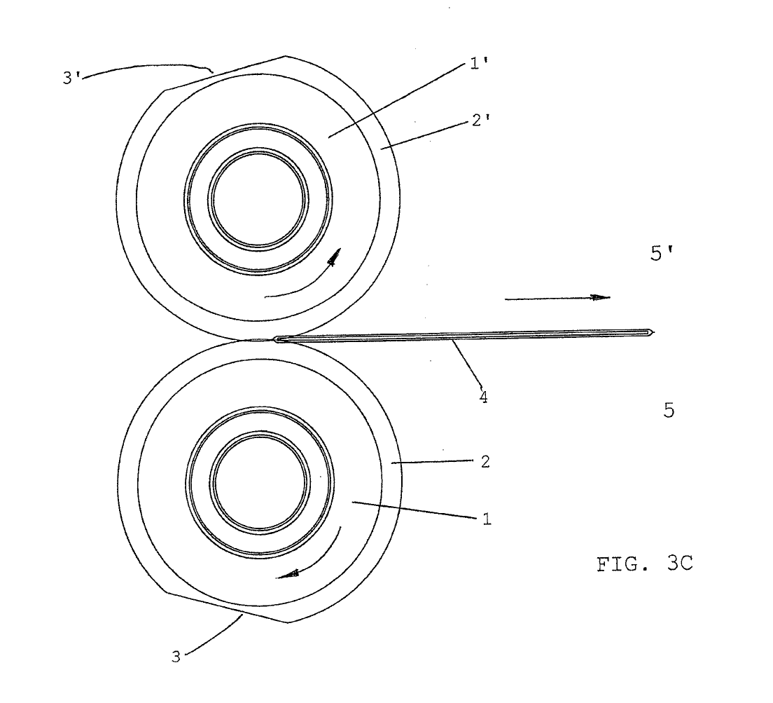

FIGS. 2a, 2b and 2c are schematic drawings of three stages in an embodiment of the lamination process, according to the present invention: FIG. 2a shows the beginning of the lamination process in which an end of the multiplicity of elements to be laminated, 4, is between but not yet in contact with the heated, coated cylinders, 5 and 5′; FIG. 2b shows the multiplicity of elements, 4, just at the start of the lamination process as pair of heated, coated driven cylinders, 5 and 5′, come into contact with the multiplicity of elements to be laminated, 4; and FIG. 2c shows the situation after lamination as the laminated multiplicity of elements, 4, leaves the pair of heated, coated driven cylinders, 5 and 5′. FIGS. 3a, 3b and 3c are side-on schematic drawings of the three stages in the lamination process, according to the present invention, shown in FIGS. 2a, 2b and 2c.

According to a first embodiment of the lamination process, according to the present invention, the failure to make physical contact with one another in operation is due to a non-coated area strip on at least one of the coated driven cylinders.

According to a second embodiment of the lamination process, according to the present invention, the failure to make physical contact with one another in operation is due to a non-coated area strip on both of the coated driven cylinders.

According to a third embodiment of the lamination process, according to the present invention, the failure to make physical contact with one another in operation is due to a concave strip of the thermally conductive elastic material on at least one of the driven cylinders.

According to a fourth embodiment of the lamination process, according to the present invention, the failure to make physical contact with one another in operation is due to a concave strip of the thermally conductive elastic material on both of the driven cylinders.

According to a fifth embodiment of the lamination process, according to the present invention, the failure to make physical contact with one another in operation is due to the elastic coating on at least one of the cylinders having at least one flat area over the whole length of the cylinder parallel to the axis of the cylinder which has a symmetrical profile perpendicular to the axis.

According to a sixth embodiment of the lamination process, according to the present invention, the failure to make physical contact with one another in operation is due to the elastic coating on both of the cylinders having at least one flat area over the whole length of the cylinder parallel to the axis of the cylinder which has a symmetrical profile perpendicular to the axis.

According to a seventh embodiment of the lamination process, according to the present invention, the multiplex entity is an identification document precursor.

For lamination of a multilayer polyester-based support on both sides with a PET-foil coated with polyethylene, the temperature of the aluminium cylinder is regulated to a temperature of ca. 200° C. (190° to 210° C.) and filled silicone rubber as the thermally conductive elastic material is heated to a temperature of ca. 180° C. (165 to 190°). In this case the multiplex card should be heated to a minimum of 104° C. during the lamination process.

### Supports

Polymeric type supports include cellulose acetate propionate or cellulose acetate butyrate, polyesters such as polyethylene terephthalate and polyethylene naphthalate, polyvinylchloride, polyamides, polycarbonates, polyimides, polyolefins, poly(vinylacetals), polyethers and polysulfonamides. Other examples of useful high-quality polymeric supports for the present invention include opaque white polyesters and extrusion blends of polyethylene terephthalate and polypropylene. Polyester film supports and especially poly(ethylene terephthalate) and glycol modified poly(ethylene terephthalate) (=PET-G) are preferred. When such a polyester is used as the support material, a subbing layer may be employed to improve the bonding of the ink-receiving layer to the support. Useful subbing layers for this purpose are well known in the photographic art and include, for example, polymers of vinylidene chloride such as vinylidene chloride/acrylonitrile/acrylic acid terpolymers or vinylidene chloride/methyl acrylate/itaconic acid terpolymers.

Having described in detail preferred embodiments of the current invention, it will now be apparent to those skilled in the art that numerous modifications can be made therein without departing from the scope of the invention as defined in the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A laminator for multiplex entities comprising at least one pair of driven cylinders, the outermost surface of said cylinders being coated with a thermally conductive elastic material such that in operation the cylinders fail to make physical contact with one another for a period during each rotation, wherein each of said cylinders is provided with at least one heating means, said elastic material coating has a constant thickness for at least 50% of the circumference of said cylinders and said part of the circumference of said cylinders with an elastic material having a constant thickness is at least the length of said multiplex entities in the transport direction thereof.

2. The laminator for multiplex entities according to claim 1, wherein said failure to make physical contact with one another in operation is due to a non-coated area strip on at least one of said coated driven cylinders.

3. The laminator according to claim 1, wherein said failure to make physical contact with one another in operation is due to a non-coated area strip on both of said coated driven cylinders.

4. The laminator for multiplex entities according to claim 1, wherein said failure to make physical contact with one another in operation is due to a concave strip of said thermally conductive elastic material on at least one of said driven cylinders.

5. The laminator for multiplex entities according to claim 1, wherein said failure to make physical contact with one another in operation is due to a concave strip of said thermally conductive elastic material on both of said driven cylinders.

6. The laminator for multiplex entities according to claim 1, wherein said failure to make physical contact with one another in operation is due to said elastic coating on at least one of said cylinders having at least one flat area over the whole length of the cylinder parallel to the axis of the cylinder which has a symmetrical profile perpendicular to the axis.

7. The laminator for multiplex entities according to claim 1, wherein said failure to make physical contact with one another in operation is due to said elastic coating on both of said cylinders having at least one flat area over the whole length of the cylinder parallel to the axis of the cylinder which has a symmetrical profile perpendicular to the axis.

8. The laminator according to claim 1, wherein said laminator additionally comprises two further pairs of driven cylinders, each having the same configuration as the pair of driven cylinders and said two further pairs of driven cylinders are each provided with at least one heating means.

9. The laminator according to claim 1, wherein said multiplex entity is an identification document precursor.

10. A lamination process for producing a multiplex entity comprising the steps of:
providing at least one pair of driven cylinders, the outermost surface of said cylinders being coated with a thermally conductive elastic material such that in operation the cylinders fail to make physical contact with one another for a period during each rotation, wherein each of said cylinders is provided with at least one heating means, said elastic material coating has a constant thickness for at least 50% of the circumference of said cylinders and said part of the circumference of said cylinders with an elastic material having a constant thickness is at least the length of said multiplex entity in the transport direction thereof; and
transporting a multiplicity of elements to be laminated so that the initial part of said multiplicity of elements to be laminated is not touched by said coated cylinders and the rest of said multiplicity of elements to be laminated is laminated in the nip formed by the areas of the elastic coating having a constant thickness of said cylinders.

11. The lamination process according to claim 10, wherein said failure to make physical contact with one another in operation is due to a non-coated area strip on at least one of said coated driven cylinders.

12. The lamination process according to claim 10, wherein said failure to make physical contact with one another in operation is due to a non-coated area strip on both of said coated driven cylinders.

13. The lamination process according to claim 10, wherein said failure to make physical contact with one another in operation is due to a concave strip of said thermally conductive elastic material on at least one of said driven cylinders.

14. The lamination process according to claim 10, wherein said failure to make physical contact with one another in operation is due to a concave strip of said thermally conductive elastic material on both of said driven cylinders.

15. The lamination process according to claim 10, wherein said failure to make physical contact with one another in operation is due to said elastic coating on at least one of said cylinders having at least one flat area over the whole length of the cylinder parallel to the axis of the cylinder which has a symmetrical profile perpendicular to the axis.

16. The lamination process according to claim 10, wherein said failure to make physical contact with one another in operation is due to said elastic coating on both of said cylinders having at least one flat area over the whole length of the cylinder parallel to the axis of the cylinder which has a symmetrical profile perpendicular to the axis.

17. The lamination process according to claim 10, wherein said multiplex entity is an identification document precursor.
